(19) United States
(12) Patent Application Publication
(10) Pub. No.: US 2023/0381815 A1
(43) Pub. Date: Nov. 30, 2023

(54) TRANSDUCER DEVICE AND METHOD OF MANUFACTURE

(71) Applicant: Taiwan Semiconductor Manufacturing Co., Ltd., Hsinchu (TW)

(72) Inventors: Chi-Yuan Shih, Hsinchu (TW); Shih-Fen Huang, Jhubei (TW); Yan-Jie Liao, Hsinchu (TW); Wen-Chuan Tai, Hsinchu (TW)

(21) Appl. No.: 17/752,558

(22) Filed: May 24, 2022

(51) Int. Cl. B06B 1/02

(52) U.S. Cl. CPC B06B 1/0292

(57) ABSTRACT

A method of forming a transducer includes depositing a first dielectric layer on a first electrode, patterning the first dielectric layer to form first protrusions and second protrusions, where a first diameter of each of the first protrusions is larger than a second diameter of each of the second protrusions; and bonding the first dielectric layer to a second electrode using a second dielectric layer, where sidewalls of the second dielectric layer define a cavity disposed between the first electrode and the second electrode, and where the first protrusions are disposed in the cavity.

### BACKGROUND

Micro-electronic mechanical systems (MEMS) Transducers are devices that transform input signals of one form into output signals of a different form. Example MEMS transducers include, heat sensors, pressure sensors, light sensors, and acoustic sensors. An example of an acoustic sensor is an ultrasonic transducer, which may be implemented in medical imaging, non-destructive evaluation, and other applications. MEMS transducers may include capacitive micromachined ultrasonic transducer (“CMUT”) devices, which are MEMS devices that generally combine mechanical and electronic components that operate together.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1 through 3A illustrate cross-sectional views of intermediate stages in the manufacturing of a transducer device 20, in accordance with some embodiments.

FIG. 3B illustrates a top-down view of an intermediate stage in the manufacturing of the transducer device 20, in accordance with some embodiments.

FIGS. 4 through 8 illustrate cross-sectional views of intermediate stages in the manufacturing of the transducer device 20, in accordance with some embodiments.

FIGS. 9 and 10A illustrate cross-sectional views of intermediate stages in the manufacturing of the transducer device 40, in accordance with some embodiments.

FIG. 10B illustrates a top-down view of an intermediate stage in the manufacturing of the transducer device 40, in accordance with some embodiments.

FIGS. 11 through 17 illustrate cross-sectional views of intermediate stages in the manufacturing of the transducer device 40, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Various embodiments provide methods of forming a transducer device that include forming a first dielectric layer on a bottom electrode, and then patterning the first dielectric layer to form protrusions over the bottom electrode. The protrusions over a central portion of the bottom electrode may have larger widths than protrusions over an outer portion of the bottom electrode. A second dielectric layer is then formed over the first dielectric layer and the bottom electrode, and a cavity is formed in the second dielectric layer. A top electrode is then bonded to the second dielectric layer such that the cavity is disposed between the bottom electrode and the top electrode. Advantageous features of one or more embodiments disclosed herein may include a reduction of accumulated charge in the first dielectric layer as a result of a smaller contact area due to the protrusions, leading to smaller shifts in transducer electrical performance and improved device reliability. In addition, there is mitigation of the higher contact stresses that are present in protrusions over the central portion as compared to the contact stresses that are present in protrusions over the outer portion because the protrusions over the central portion have larger widths. This results in reduced surface wear-out, and enhanced transducer device lifetime.

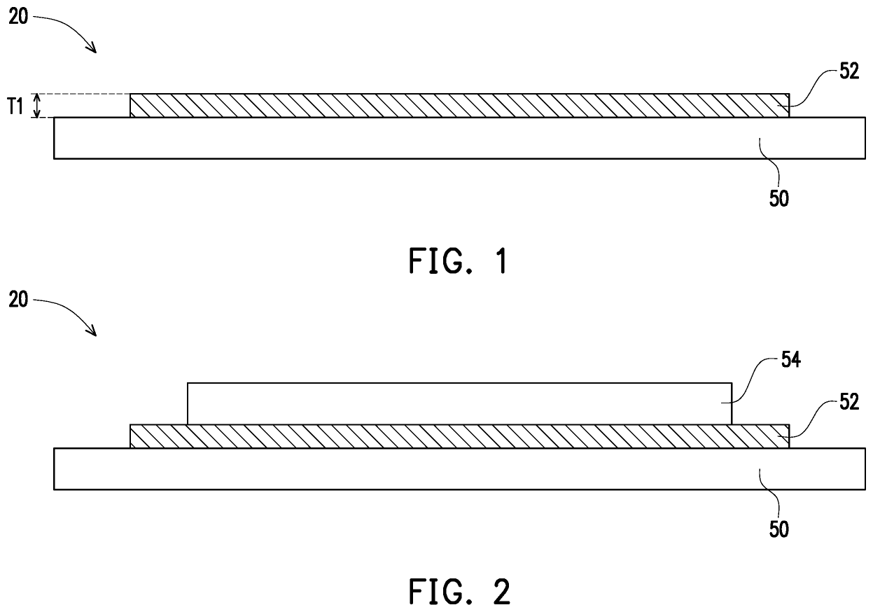

FIGS. 1 through 8 illustrate cross-sectional views and top-down views of intermediate steps in the forming of a transducer device 20. FIG. 1 illustrates a substrate 50. The substrate 50 may comprise a material such as silicon, quartz, glass, or the like. If the substrate 50 is silicon, the substrate 50 may be doped or undoped. In other embodiments, the substrate 50 may contain integrated electronics to generate and process input and output signals for the transducer device 20.

Referring further to FIG. 1, a conductive layer is then formed on the substrate 50, and the conductive layer is patterned using acceptable photolithography and etching techniques to form a bottom electrode 52. The conductive layer may be formed using a deposition technique such as plating (e.g., electroplating or electroless plating), chemical vapor deposition (CVD), physical vapor deposition (PVD), atomic layer deposition (ALD, or the like. The conductive layer may comprise a metal or a metal compound such as copper, a copper alloy, silver, gold, tungsten, cobalt, aluminum, nickel, or the like. In an embodiment, the conductive layer may comprise polysilicon, doped polysilicon, TiN, TaN, or the like. In an embodiment, the bottom electrode 52 may have a thickness T1 that is in a range from 0.01 μm to 0.1 μm.

In FIG. 2, a dielectric layer 54 is deposited on the bottom electrode 52 and the substrate 50 using a suitable method such as CVD, ALD, or the like. The dielectric layer 54 may comprise silicon oxide (for example, SiO₂), doped silicon oxide (e.g., boron or phosphorus doped SiO₂), SiON, SiN, a metal oxide, a carbide, or the like. In other embodiments, the dielectric layer 54 may be formed of a ceramic material. The dielectric layer 54 may also be referred to subsequently as an insulation layer. A photoresist is then formed over the dielectric layer 54 and patterned (using e.g., a combination of exposure and development) to expose edge portions of the dielectric layer 54. The exposed edge portions of the dielectric layer 54 are then removed by an etching process that uses the patterned photoresist as a mask. The etching process may comprise a dry or wet etch. For example, the etching process may comprise a buffered oxide etch (BOE) process that includes hydrofluoric acid (HF) as an etchant. After the etching process is performed, the photoresist may be removed through a suitable removal process such as ashing or chemical stripping.

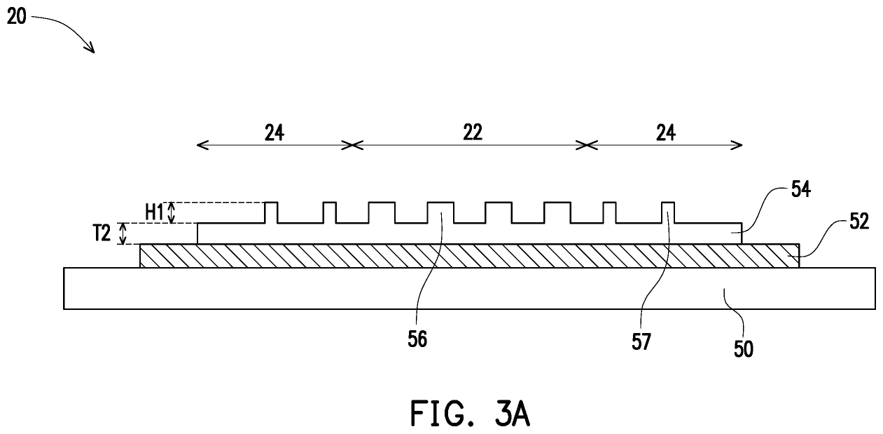

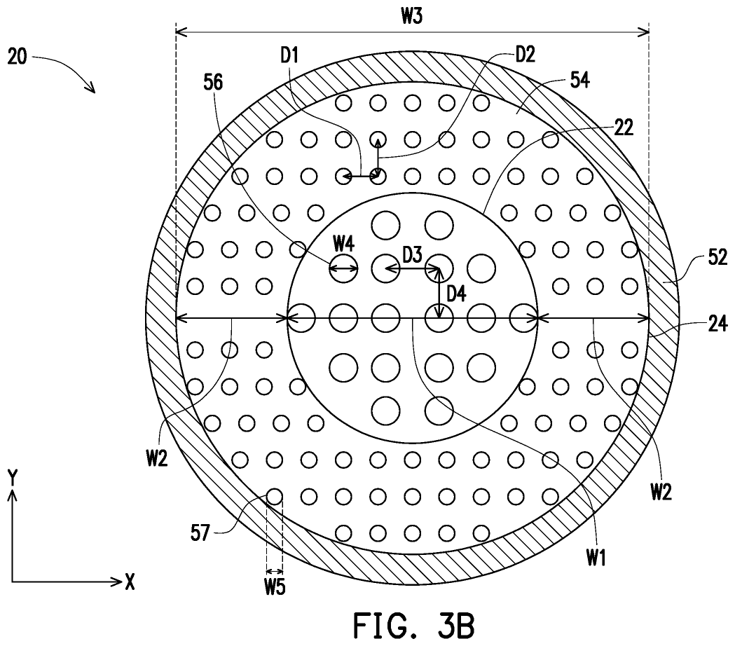

FIG. 3A illustrates a cross-sectional view of the transducer device 20 after upper portions of the dielectric layer 54 are patterned to form protrusions 56 and protrusions 57. FIG. 3B illustrates a top-down view of the transducer device 20 shown in FIG. 3A, with the substrate 50 omitted for reasons of clarity. In FIG. 3A, a patterned photoresist is formed over the dielectric layer 54, the substrate 50, and the bottom electrode 52. A wet etch process is performed using the patterned photoresist as a mask to etch upper portions of the dielectric layer 54 and form the protrusions 56 and the protrusions 57. In an embodiment, the wet etch process may be a timed etch process. In an embodiment in which the dielectric layer 54 comprises SiO₂ or doped SiO₂, the wet etch process may comprise etchants that include ammonium fluoride (NH₄F), hydrofluoric acid (HF), a combination thereof, or the like. In an embodiment in which the dielectric layer 54 comprises SiN or SiON, the wet etch process may comprise etchants that include phosphoric acid, or the like. In an embodiment, the protrusions 56 and 57 may have a height H1 that is in a range from 0.001 μm to 0.5 μm. In an embodiment, a lower portion of the dielectric layer 54 that is not etched during the wet etch process may have a thickness T2 that is in a range from 0.001 μm to 0.5 μm.

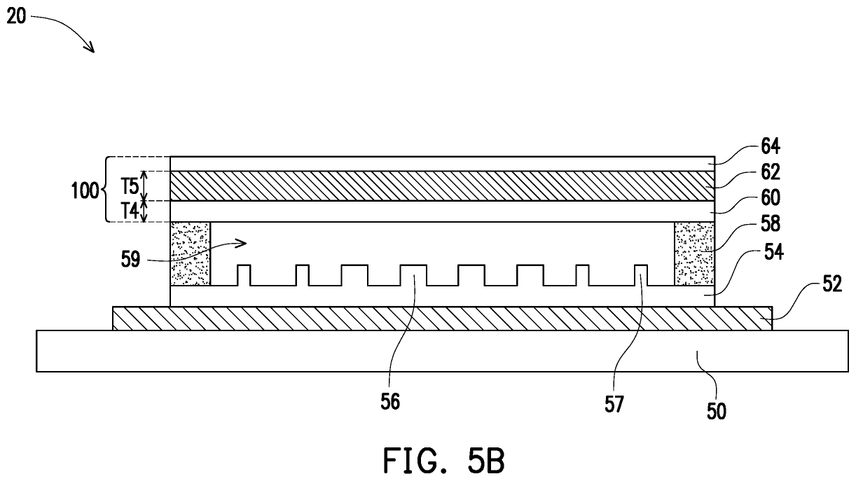

The protrusions 56 and the protrusions 57 may be formed such that they are formed in different regions of the dielectric layer 54 and may have different widths. The protrusions 56 and 57 may also be referred to subsequently as pillars. In an embodiment, the protrusions 56 may be formed in a central region 22 (also shown subsequently in FIG. 3B) of the dielectric layer 54 and may have larger widths than the protrusions 57 that are formed in an outer region 24 (also shown subsequently in FIG. 3B) of the dielectric layer 54. Further, in some embodiments, a surface roughness of top surfaces of the protrusions 56 in the central region 22 may be greater than a surface roughness of top surfaces of the protrusions 57 in the outer region 24. The surface roughness of the top surfaces of the protrusions 56 can be increased by increasing a contact force of a subsequently formed structure 100 (shown in FIG. 5B) during operation of the transducer device 20.

FIG. 3B shows a top-down view of the central region 22 and the outer region 24 of the dielectric layer 54. As illustrated, the central region 22 has a circular outer perimeter that is surrounded by the outer region 24. The outer region 24 may also have a circular outer perimeter and be annular in shape. In an embodiment, a spacing between the protrusions 57 may be the same as a spacing between the protrusions 56. For example, a distance D1 between center points of adjacent protrusions 57 in a first direction (e.g., the x-direction) in the outer region 24 is equal to a distance D3 between center points of adjacent protrusions 56 in the first direction (e.g., the x-direction) in the central region 22. Further, a distance D2 between center points of adjacent protrusions 57 in a second direction (e.g., the y-direction) in the outer region 24 is equal to a distance D4 between center points of adjacent protrusions 56 in the second direction (e.g., the y-direction) in the central region 22. In an embodiment, the distance D1, the distance D2, the distance D3, and the distance D4 are equal. Although FIG. 3B shows a certain number of protrusions 56 and protrusions 57 arranged in a first configuration, any number of protrusions 56 and protrusions 57 can be arranged in any configuration with their proportions drawn to a different scale than shown. In an embodiment, the central region 22 may have a width W1, which may correspond to a diameter of the central region 22, and the outer region 24 may have a width W2, which may correspond to a difference between an inner radius of the outer region 24 and the outer radius of the outer region 24. In an embodiment, the central region 22 and the outer region 24 may have a combined width W3, which may correspond to a diameter of the combined regions 22 and 24. In an embodiment, the width W1 may be in a range from 10 percent to 70 percent of the width W3. In an embodiment, the width W2 may be in a range from 30 percent to 90 percent of the width W3. In an embodiment, the central region 22 may have an area that is different than an area of the outer region 24. In an embodiment, a ratio between the area of the central region 22 and the area of the outer region 24 is in a range from 3:1 to 1:20.

The protrusions 56 and 57 may each be a pillar having a circular or ovular shape in a top-down view. The protrusion 56 may have a width W4 (e.g., a diameter of the protrusion 56) that is in a range from 0.5 μm to 10 μm. The protrusion 57 may have a width W5 (e.g., a diameter of the protrusion 57) that is in a range from 0.5 μm to 10 μm. In an embodiment, the width W4 is larger than the width W5. For example, the width W4 may be in a range from 3 μm to 10 μm, and the width W5 may be in a range from 0.5 μm to 2 μm. In an embodiment, an area of each of the protrusions 56 may be greater than an area of each of the protrusions 57. In an embodiment, a ratio between the area of the protrusion 56 and the area of the protrusion 57 is in a range from 1.1:1 to 50:1. Advantages can be achieved as a result of forming the protrusions 56 and 57 having the widths W4 and W5 respectively, where the widths are in a range from 0.5 μm to 10 μm. These advantages include a reduction of accumulated charge in the dielectric layer 54 as a result of a smaller contact area due to the protrusions 56 and 57, leading to smaller shifts in transducer electrical performance and improved device reliability. Further advantages can also be achieved as a result of forming the protrusions 56 and 57 such that an area (and also the width W4) of each of the protrusions 56 is greater than an area (and also the width W5) of each of the protrusions 57, and a ratio between the area of each of the protrusions 56 and the area of each of the protrusions 57 is in a range from 1.1:1 to 50:1. This includes a mitigation of the contact stresses in protrusions over the central region 22.

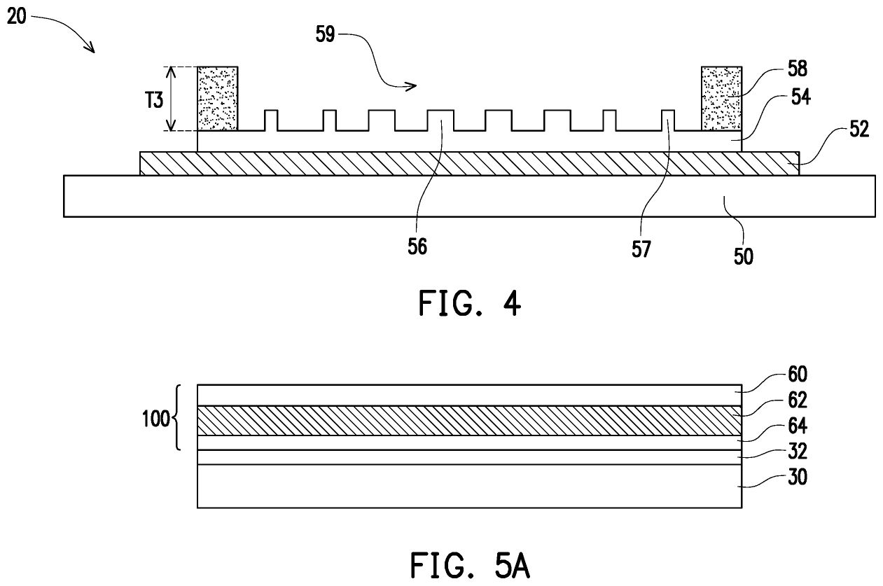

In FIG. 4, a dielectric layer 58 is deposited over the bottom electrode 52, the substrate 50 and the dielectric layer 54 (including the protrusions 56 and 57) using any suitable method, such as CVD, ALD, or the like. The dielectric layer 58 may comprise silicon oxide (e.g., SiO₂), doped silicon oxide (e.g., boron or phosphorus doped SiO₂), SiON, SiN, a metal oxide, a carbide, or the like. In an embodiment, the dielectric layer 58 may have a thickness T3 that is in a range from 0.01 μm to 1 μm. A cavity 59 is then formed in the dielectric layer 58. The cavity 59 may be formed by methods that include forming a patterned photoresist over the dielectric layer 58, the substrate 50, and the bottom electrode 52, and using an etching process to etch the dielectric layer 58 using the patterned photoresist as an etching mask to expose top surfaces and sidewalls of the dielectric layer 54 (including the protrusions 56 and 57) and top surfaces of the bottom electrode 52. In an embodiment, a material of the dielectric layer 58 is different from a material of the dielectric layer 54 and the etching process may selectively etch the dielectric layer 58 without etching the dielectric layer 54 (including the protrusions 56 and 57). In an embodiment in which a material of the dielectric layer 54 is different from a material of the dielectric layer 58, the dielectric layer 54 may comprise SiO₂ and the dielectric layer 58 may comprise SiN, and the etching process may be a wet etch process that includes CF₄ as an etchant. In an embodiment where the dielectric layer 54 and the dielectric layer 58 comprise the same material (e.g., SiO₂), an etch stop layer comprising SiN may be formed over the dielectric layer 54 (including the protrusions 56 and 57), prior to forming the dielectric layer 58. In such a case, the etching process may comprise a wet etch process such as a buffered oxide etch (BOE) that includes hydrofluoric acid (HF) as an etchant. After the etching process is performed, the etch stop layer may also be removed using a further etching process that comprises CF₄ as an etchant.

FIG. 5A illustrates the formation of a structure 100 that will be subsequently bonded to the dielectric layer 58 (as shown in FIG. 5B). In FIG. 5A, a carrier substrate 30 is shown. The carrier substrate 30 may comprise silicon-based materials, such as a silicon substrate (e.g., a silicon wafer), a glass material, silicon oxide, or other materials, such as aluminum oxide, the like, or a combination. An adhesive layer 32 is formed on the carrier substrate 30 to facilitate a subsequent debonding of the structure 100 from the carrier substrate 30. The adhesive layer 32 may comprise a polymer-based material, which may be removed along with the carrier substrate 30 from the structure 100. In some embodiments, the adhesive layer 32 may comprise an epoxy-based thermal-release material, which loses its adhesive property when heated, such as a Light-to-Heat-Conversion (LTHC) release coating. In some embodiments, the adhesive layer 32 may comprise an ultra-violet (UV) glue, which loses its adhesive property when exposed to UV light. In some embodiments, the adhesive layer 32 may comprise pressure sensitive adhesives, radiation curable adhesives, epoxies, combinations of these, or the like. The adhesive layer 32 may be placed onto the carrier substrate 30 in a semi-liquid or gel form, which is readily deformable under pressure.

Referring further to FIG. 5A, a dielectric layer 64 is then deposited over the adhesive layer 32 using any suitable method, such as CVD, ALD, or the like. The dielectric layer 64 may comprise silicon oxide (e.g., SiO₂), doped silicon oxide (e.g., doped SiO₂), SiON, SiN, a metal oxide, a carbide, or the like. After depositing the dielectric layer 64, a conductive layer is then formed on the dielectric layer 64 to form a top electrode 62. The top electrode 62 may be formed using a deposition technique such as plating (e.g., electroplating or electroless plating), or the like. In other embodiments, a deposition technique such as chemical vapor deposition (CVD), atomic layer deposition (ALD), or the like, may be used to form the top electrode 62. The conductive layer may comprise a metal or a metal compound such as copper, a copper alloy, silver, gold, tungsten, cobalt, aluminum, nickel, or the like. In an embodiment, the conductive layer may comprise polysilicon, doped polysilicon, TiN or TaN. A dielectric layer 60 is then deposited over the top electrode 62 using any suitable method, such as CVD, ALD, or the like. The dielectric layer 60 may comprise silicon oxide (e.g., SiO₂), doped silicon oxide (e.g., doped SiO₂), SiON, SiN, a metal oxide, a carbide, or the like.

In FIG. 5B, the carrier substrate 30 and the structure 100 are flipped over and the dielectric layer 60 of the structure 100 is bonded to the dielectric layer 58 through dielectric-to-dielectric bonding (such that there is no use of external connectors such as solder, or the like). Prior to bonding, at least one of the surfaces of the dielectric layer 60 or the dielectric layer 58 are subjected to a surface treatment. The surface treatment may include a plasma treatment. The plasma treatment may be performed in a vacuum environment. After the plasma treatment, the surface treatment may further include a cleaning process (e.g., a rinse with deionized water, or the like). The bonding may include a pre-bonding and an annealing. During the pre-bonding, the structure 100 is aligned with the dielectric layer 58 and a small pressing force is applied to press the carrier substrate 30 against the dielectric layer 58. The pre-bonding is performed at a low temperature, such as room temperature, such as a temperature in the range of 15° C. to 30° C., and after the pre-bonding, the dielectric layer 58 and the dielectric layer 60 are bonded to each other with van der Waals bonds. The bonding strength may then be improved in a subsequent annealing step, in which the dielectric layer 58 and the dielectric layer 60 are annealed at a high temperature, such as a temperature in the range of 140° C. to 500° C. After the annealing, bonds, such as fusions bonds, are formed bonding the dielectric layer 58 and the dielectric layer 60. For example, the bonds can be covalent bonds between the material of the dielectric layer 58 and the material of the dielectric layer 60.

The carrier substrate 30 may then be debonded from the structure 100 using, e.g., a thermal process to alter the adhesive properties of the adhesive layer 32 disposed on the carrier substrate 30. In a particular embodiment an energy source such as an ultraviolet (UV) laser, a carbon dioxide (CO₂) laser, or an infrared (IR) laser, is utilized to irradiate and heat the adhesive layer 32 until the adhesive layer 32 loses at least some of its adhesive properties. Once performed, the carrier substrate 30 and the adhesive layer 32 may be physically separated and removed from the structure 100 leaving the dielectric layer 58 and the cavity 59 disposed between the structure 100 and the dielectric layer 54. In an embodiment, the dielectric layer 60 may have a thickness T4 that is in a range from 0.05 μm to 0.5 μm. In an embodiment, the top electrode 62 may have a thickness T5 that is in a range from 0.01 μm to 10 μm.

Advantages can be achieved as a result of forming the dielectric layer 54 on the bottom electrode 52, and then patterning the dielectric layer 54 to form the protrusions 56 and 57 over the bottom electrode 52, wherein the protrusions 56 over the central region 22 of the bottom electrode 52 have larger widths and areas than the protrusions 57 over the outer region 24 of the bottom electrode 52. The dielectric layer 58 is then formed over the dielectric layer 54 and the bottom electrode 52, and the cavity 59 is formed in the dielectric layer 58, wherein the cavity 59 is disposed between the bottom electrode 52 and the top electrode 62. The advantages of forming the protrusions 56 and 57 include a reduction of accumulated charge in the dielectric layer 54 as a result of a smaller contact area due to the protrusions 56 and 57, leading to smaller shifts in transducer electrical performance and improved device reliability. Further advantages of the protrusions 56 having larger widths and areas than the protrusions 57 include a mitigation of the higher contact stresses that would be present in protrusions over the central region 22 as compared to the contact stresses that would be present in protrusions over the outer region 24 if the protrusions in the central region 22 and outer region 24 had the same areas. This results in reduced surface wear-out and enhanced transducer device lifetime.

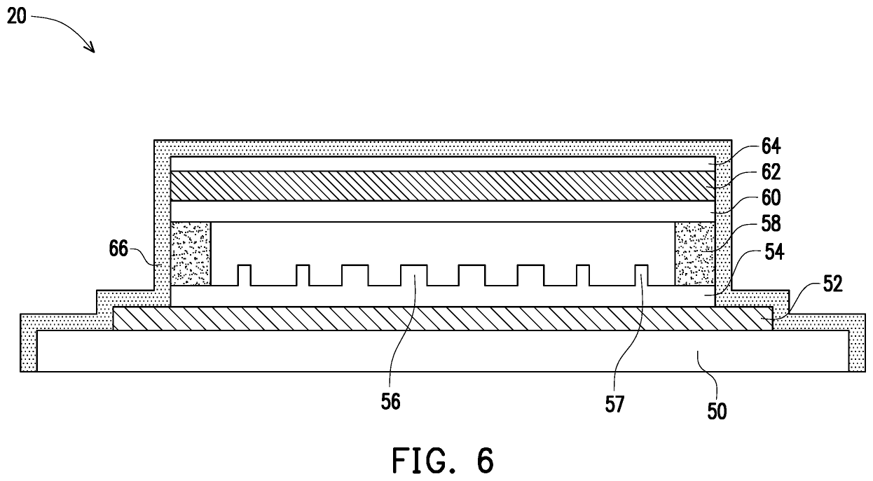

In FIG. 6, a passivation layer 66 is then deposited over the structure shown in FIG. 5B, such as over a top surface and sidewalls of the structure 100, sidewalls of the dielectric layer 58 and the dielectric layer 54, top surfaces and sidewalls of the bottom electrode 52, and top surfaces and sidewalls of the substrate 50. The passivation layer 66 may be deposited using any suitable method, such as CVD, ALD, or the like. The passivation layer 66 may comprise a dielectric material and may include silicon oxide (e.g., SiO₂), doped silicon oxide (e.g., doped SiO₂), SiON, SiN, or the like.

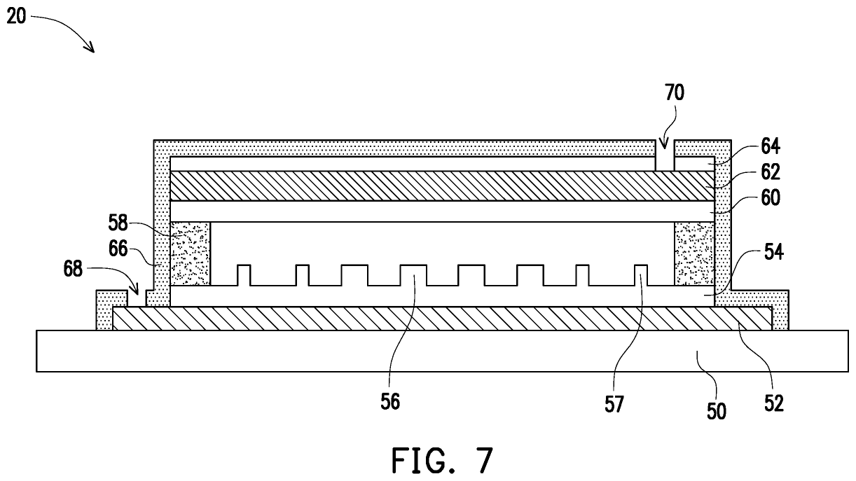

In FIG. 7, an opening 68 is formed in the passivation layer 66 to expose a top surface of the bottom electrode 52, and an opening 70 is formed in the passivation layer 66 and the dielectric layer 64 to expose a top surface of the top electrode 62. The openings 68 and 70 are formed using acceptable photolithography and etching techniques.

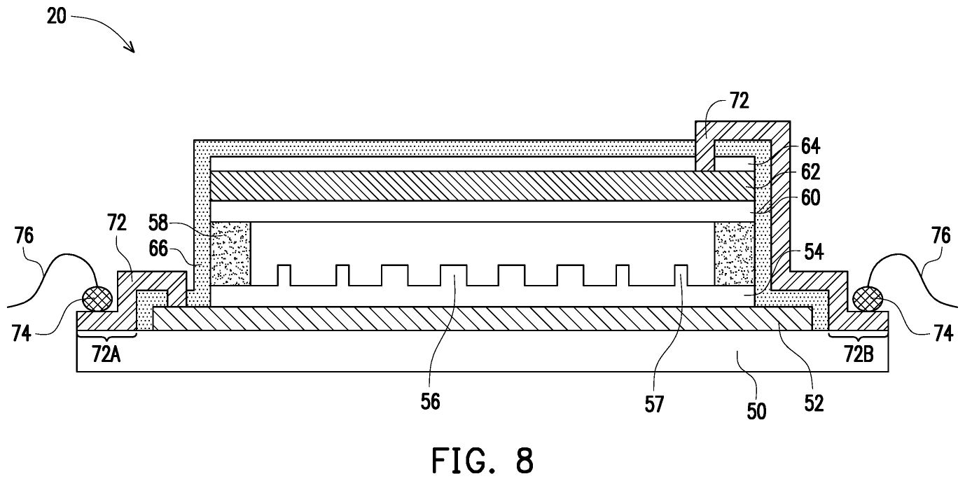

In FIG. 8, a conductive layer 72 is formed over the structure shown in FIG. 7 such as over the passivation layer 66 and the substrate 50. The conductive layer 72 also fills in the openings 68 and 70 such that the conductive layer 72 is in physical contact with the top electrode 62 and the bottom electrode 52. The conductive layer 72 may be formed using a deposition technique such as plating (e.g., electroplating or electroless plating), or the like. In other embodiments, a deposition technique such as chemical vapor deposition (CVD), atomic layer deposition (ALD), or the like, may be used to form the conductive layer 72. The conductive layer 72 may comprise a metal such as copper, a copper alloy, silver, gold, tungsten, cobalt, aluminum, nickel, or the like. The conductive layer 72 is then patterned using acceptable photolithography and etching techniques to form a first conductive pad 72A on the substrate 50 that is electrically connected to the bottom electrode 52 and a second conductive pad 72B on the substrate 50 that is electrically connected to the top electrode 62, wherein the first conductive pad 72A and the second conductive pad 72B are not electrically connected to each other.

Still referring to FIG. 8, a wire bonding process is used to form conductive connectors 74 and bond wires 76 on the first conductive pad 72A and the second conductive pad 72B. The conductive connectors 74 and bond wires 76 may be formed of copper, gold, or the like. A first voltage can be applied to the bottom electrode 52 using the first conductive pad 72A and the conductive connector 74 on the first conductive pad 72A. A second voltage can be applied to the top electrode 62 using the second conductive pad 72B and the conductive connector 74 on the second conductive pad 72B.

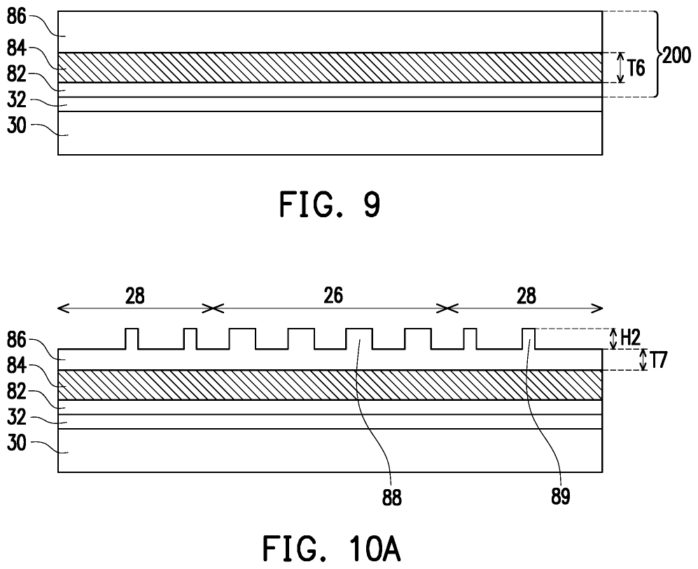

FIGS. 9 through 17 illustrate cross-sectional views and top-down views of intermediate steps in the forming of a transducer device 40. The transducer device 40 may be similar to the transducer device 20 of FIGS. 1 through 8 where like reference numerals in this embodiment (and subsequently discussed embodiments) indicate like elements formed using like processes, unless specified otherwise. Accordingly, the process steps and applicable materials may not be repeated herein.

FIG. 9 illustrates the formation of a structure 200 on a carrier substrate 30 (described previously in FIG. 5A). An adhesive layer 32 (described previously in FIG. 5A) is formed on the carrier substrate 30 to facilitate a subsequent debonding of the structure 200 from the carrier substrate 30. A dielectric layer 82 is then deposited over the adhesive layer 32 using any suitable method, such as CVD, ALD, or the like. The dielectric layer 82 may comprise silicon oxide (e.g., SiO₂), doped silicon oxide (e.g., boron or phosphorus doped SiO₂), SiON, SiN, a metal oxide, a carbide, or the like. After depositing the dielectric layer 82, a conductive layer is then formed on the dielectric layer 82 to form a top electrode 84. The top electrode 84 may be formed using a deposition technique such as plating (e.g., electroplating or electroless plating), or the like. In other embodiments, a deposition technique such as chemical vapor deposition (CVD), atomic layer deposition (ALD), or the like, may be used to form the top electrode 84. The conductive layer may comprise a metal or a metal compound such as copper, a copper alloy, silver, gold, tungsten, cobalt, aluminum, nickel, or the like. In an embodiment, the conductive layer may comprise polysilicon, doped polysilicon, TiN or TaN. In an embodiment, the top electrode 84 may have a thickness T6 that is in a range from 0.01 μm to 10 μm. A dielectric layer 86 is then deposited over the top electrode 84 using any suitable method, such as CVD, ALD, or the like. The dielectric layer 86 may comprise silicon oxide (e.g., SiO₂), doped silicon oxide (e.g., doped SiO₂), SiON, SiN, a metal oxide, a carbide, or the like. The dielectric layer 86 may also be referred to subsequently as an insulating layer.

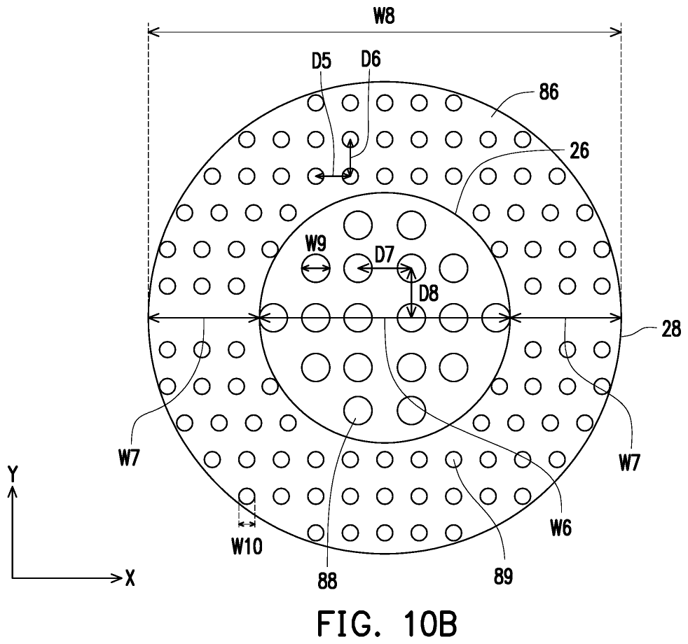

FIG. 10A illustrates a cross-sectional view of the structure shown previously in FIG. 9 after upper portions of the dielectric layer 86 are patterned to form protrusions 88 and protrusions 89. FIG. 10B illustrates a top-down view of the structure shown in FIG. 10A. In FIG. 10A, a patterned photoresist is formed over the dielectric layer 86. A wet etch process is performed using the patterned photoresist as a mask to etch upper portions of the dielectric layer 86 and form the protrusions 88 and the protrusions 89. In an embodiment, the wet etch process may be a timed etch process. In an embodiment in which the dielectric layer 86 comprises SiO₂ or doped SiO₂, the wet etch process may comprise etchants that include ammonium fluoride (NH₄F), hydrofluoric acid (HF), a combination thereof, or the like. In an embodiment in which the dielectric layer 86 comprises SiN or SiON, the wet etch process may comprise etchants that include phosphoric acid, or the like. In an embodiment, the protrusions 88 and 89 may have a height H2 that is in a range from 0.001 μm to 0.5 μm. In an embodiment, a lower portion of the dielectric layer 86 that is not etched during the wet etch process may have a thickness T7 that is in a range from 0.05 μm to 0.5 μm.

The protrusions 88 and the protrusions 89 may be formed such that they are formed in different regions of the dielectric layer 86 and may have different widths. The protrusions 88 and 89 may also be referred to subsequently as pillars. In an embodiment, the protrusions 88 may be formed in a central region 26 (also shown subsequently in FIG. 10B) of the dielectric layer 86 and may have larger widths than the protrusions 89 that are formed in an outer region 28 (also shown subsequently in FIG. 10B) of the dielectric layer 86. Further, in some embodiments, a surface roughness of top surfaces of the protrusions 88 may be greater than a surface roughness of the top surfaces of the protrusions 89. The surface roughness of the top surfaces of the protrusions 88 can be increased by increasing a contact force of the structure 200 against the dielectric 94 (shown in FIG. 14) during operation of the transducer device 40.

FIG. 10B shows the central region 26 and the outer region 28 of the dielectric layer 86. As illustrated, the central region 26 has a circular outer perimeter that is surrounded by the outer region 28. The outer region 28 may also have a circular outer perimeter and be annular in shape. In an embodiment, a spacing between the protrusions 88 may be the same as a spacing between the protrusions 89. For example, a distance D5 between center points of adjacent protrusions 89 in a first direction (e.g., the x-direction) in the outer region 28 is equal to a distance D7 between center points of adjacent protrusions 88 in the first direction (e.g., the x-direction) in the central region 26. Further, a distance D6 between center points of adjacent protrusions 89 in a second direction (e.g., the y-direction) in the outer region 28 is equal to a distance D8 between center points of adjacent protrusions 88 in the second direction (e.g., the y-direction) in the central region 26. In an embodiment, the distance D5, the distance D6, the distance D7, and the distance D8 are equal. Although FIG. 10B shows a certain number of protrusions 88 and protrusions 89 arranged in a first configuration, any number of protrusions 88 and protrusions 89 can be arranged in any configuration with their proportions drawn to a different scale than shown. In an embodiment, the central region 26 may have a width W6, which may correspond to a diameter of the central region 26 and the outer region 28 may have a width W7, which may correspond to a difference between an inner radius of the outer region 28 and the outer radius of the outer region 28. In an embodiment, the central region 26 and the outer region 28 may have a combined width W8, which may correspond to a diameter of the combined regions 26 and 28. In an embodiment, the width W6 may be in a range from 10 percent to 70 percent of the width W8. In an embodiment, the width W7 may be in a range from 30 percent to 90 percent of the width W8. In an embodiment, the central region 26 may have an area that is different than an area of the outer region 28. In an embodiment, a ratio between the area of the central region 26 and the area of the outer region 28 is in a range from 3:1 to 1:20.

The protrusions 88 and 89 may each be a pillar having a circular shape or ovular shape in a top-down view. The protrusion 88 may have a width W9 (e.g., a diameter of the protrusion 88) that is in a range from 0.5 μm to 10 μm. The protrusion 89 may have a width W10 (e.g., a diameter of the protrusion 89) that is in a range from 0.5 μm to 10 μm. In an embodiment, the width W9 is larger than the width W10. For example, the width W9 may be in a range from 3 μm to 10 μm, and the width W10 may be in a range from 0.5 μm to 2 μm. In an embodiment, an area of each of the protrusions 88 may be greater than an area of each of the protrusions 89. In an embodiment, a ratio between the area of the protrusion 88 and the area of the protrusion 89 is in a range from 1.1:1 to 50:1. Advantages can be achieved as a result of forming the protrusions 88 and 89 having the widths W9 and W10 respectively, where the widths are in a range from 0.5 μm to 10 μm. These advantages include a reduction of accumulated charge in the dielectric layer 86 as a result of a smaller contact area due to the protrusions 88 and 89, leading to smaller shifts in transducer electrical performance and improved device reliability. Further advantages can also be achieved as a result of forming the protrusions 88 and 89 such that an area (and also the width W9) of each of the protrusions 88 is greater than an area (and also the width W10) of each of the protrusions 89, and a ratio between the area of each of the protrusions 88 and the area of each of the protrusions 89 is in a range from 1.1:1 to 50:1. This includes a mitigation of the contact stresses in protrusions over the central region 26.

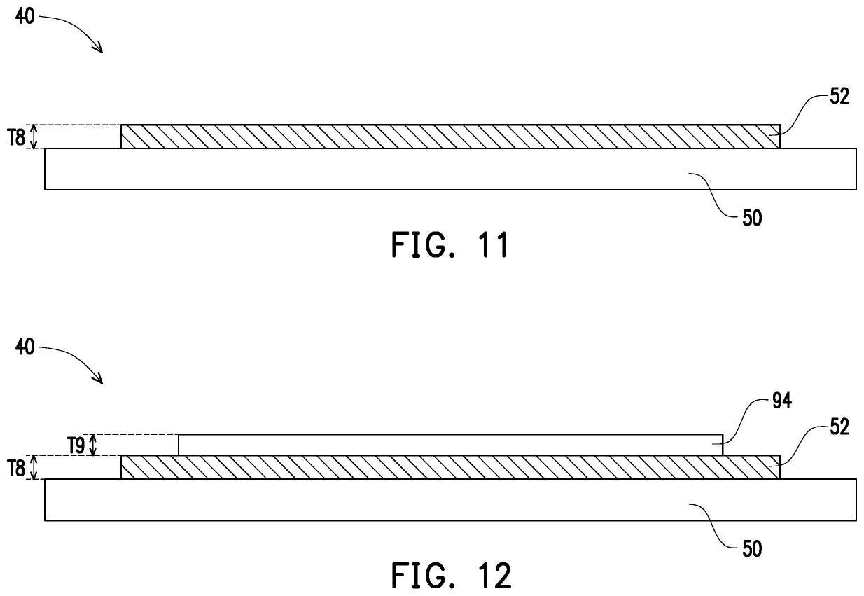

FIG. 11 illustrates a substrate 50 (described previously in FIG. 1). A bottom electrode 52 is then formed on the substrate 50 using similar materials and processes as those described previously in FIG. 1. In an embodiment, the bottom electrode 52 may have a thickness T8 that is in a range from 0.01 μm to 0.1 μm.

In FIG. 12, a dielectric layer 94 is deposited on the bottom electrode 52 and the substrate 50 using a suitable method such as CVD, ALD, or the like. The dielectric layer 94 may comprise silicon oxide (e.g., SiO₂), doped silicon oxide (e.g., doped SiO₂), SiON, SiN, a metal oxide, a carbide, or the like. In other embodiments, the dielectric layer 94 may be formed of a ceramic material. The dielectric layer 94 may also be referred to subsequently as an insulation layer. A photoresist is then formed over the dielectric layer 94 and patterned (using e.g., a combination of exposure and development) to expose edge portions of the dielectric layer 94. The exposed edge portions of the dielectric layer 94 are then removed by an etching process that uses the patterned photoresist as a mask. The etching process may comprise a dry or a wet etch process. For example, if the dielectric layer 94 comprises SiO₂, the etching process may comprise a buffered oxide etch (BOE) that includes hydrofluoric acid (HF) as an etchant. In an embodiment in which the dielectric layer 94 comprises SiN, the etching process may comprise phosphoric acid as an etchant. After the etching process is performed, the photoresist may be removed through a suitable removal process such as ashing or chemical stripping. In an embodiment, the dielectric layer 94 may have a thickness T9 that is in a range from 0.001 μm to 0.5 μm.

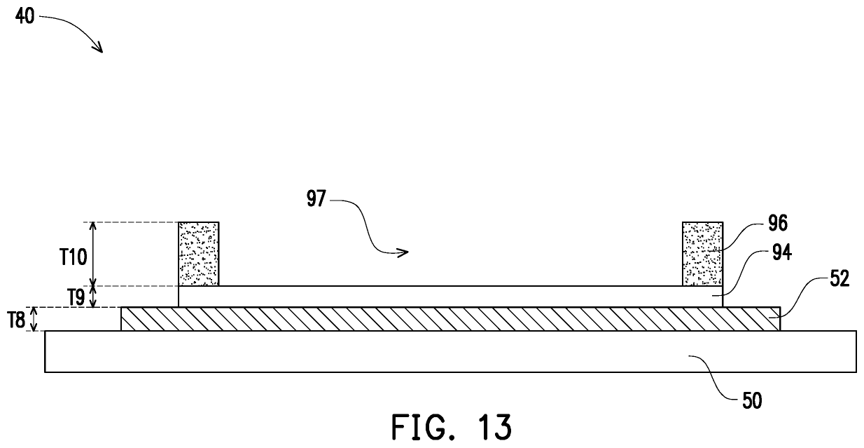

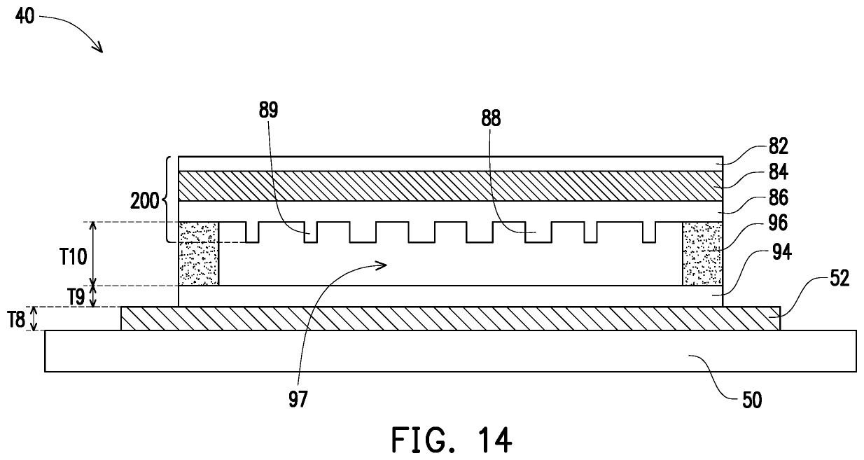

In FIG. 13, a dielectric layer 96 is deposited over the bottom electrode 52, the substrate 50 and the dielectric layer 94 using any suitable method, such as CVD, ALD, or the like. The dielectric layer 96 may comprise silicon oxide (e.g., SiO₂), doped silicon oxide (e.g., boron or phosphorus doped SiO₂), SiON, SiN, a metal oxide, a carbide, or the like. In an embodiment, the dielectric layer 96 may have a thickness T10 that is in a range from 0.01 μm to 1 μm. A cavity 97 is then formed in the dielectric layer 96. The cavity 97 may be formed by methods that include forming a patterned photoresist over the substrate 50, the bottom electrode 52, and the dielectric layer 96, and using an etching process to etch the dielectric layer 96 using the patterned photoresist as an etching mask to expose a top surface of the dielectric layer 94 and top surfaces of the bottom electrode 52. In an embodiment, a material of the dielectric layer 96 is different from a material of the dielectric layer 94 and the etching process may selectively etch the dielectric layer 96 without etching the dielectric layer 94. In an embodiment in which a material of the dielectric layer 96 is different from a material of the dielectric layer 94, the dielectric layer 94 may comprise SiN and the dielectric layer 96 may comprise SiO₂, and the etching process may be a wet etch process that comprises a buffered oxide etch (BOE) that includes hydrofluoric acid (HF) as an etchant. In an embodiment in which the dielectric layer 94 comprises SiO₂ and the dielectric layer 96 comprises SiN, the etching process may include CF₄ as an etchant.

In FIG. 14, the carrier substrate 30 (shown previously in FIG. 10A) and the structure 200 (shown previously in FIG. 10A) are flipped over and the dielectric layer 86 of the structure 200 is bonded to the dielectric layer 96 through dielectric-to-dielectric bonding in a similar manner and using similar processes as those described previously in FIG. 5B for the bonding of the dielectric layer 60 of the structure 100 to the dielectric layer 58.

The carrier substrate 30 may then be debonded from the structure 200 in a similar manner and using similar processes as those described previously in FIG. 5B for the debonding of the carrier substrate 30 from the structure 100. Once performed, the carrier substrate 30 and the adhesive layer 32 may be physically separated and removed from the structure 200 leaving the dielectric layer 96 and the cavity 97 disposed between the structure 200 and the dielectric layer 94.

Advantages can be achieved as a result of forming the structure 200, wherein the dielectric layer 86 is formed on the top electrode 84, and the dielectric layer 86 is patterned to form the protrusions 88 and 89 over the top electrode 84, wherein the protrusions 88 over the central region 26 of the top electrode 84 have larger widths and areas than the protrusions 89 over the outer region 28 of the top electrode 84. The dielectric layers 94 and 96 are formed over the bottom electrode 52, and the cavity 97 is formed in the dielectric layer 96. The structure 200 is bonded to the dielectric layer 96 such that the dielectric layer 86 (including the protrusions 88 and 89) and the cavity 97 are disposed between the bottom electrode 52 and the top electrode 84. The advantages of forming the protrusions 88 and 89 include a reduction of accumulated charge in the dielectric layer 86 as a result of a smaller contact area due to the protrusions 88 and 89, leading to smaller shifts in transducer electrical performance and improved device reliability. Further advantages of the protrusions 88 having larger widths and areas than the protrusions 89 include a mitigation of the higher contact stresses that would be present in protrusions over the central region 26 as compared to the contact stresses that would be present in protrusions over the outer region 28 if the protrusions in the central region 26 and outer region 28 had the same areas. This results in reduced surface wear-out and enhanced transducer device lifetime.

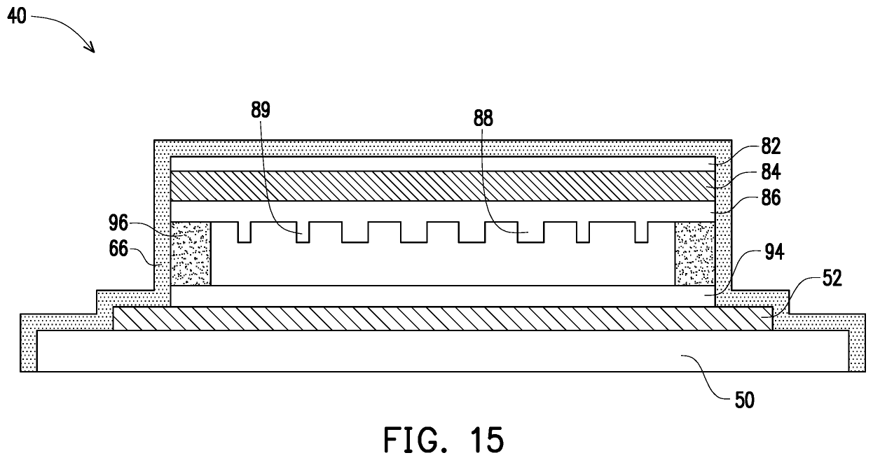

In FIG. 15, a passivation layer 66 (described previously in FIG. 6) is then deposited over the structure shown in FIG. 14, such as over a top surface and sidewalls of the structure 200, sidewalls of the dielectric layer 96 and the dielectric layer 94, top surfaces and sidewalls of the bottom electrode 52, and top surfaces and sidewalls of the substrate 50.

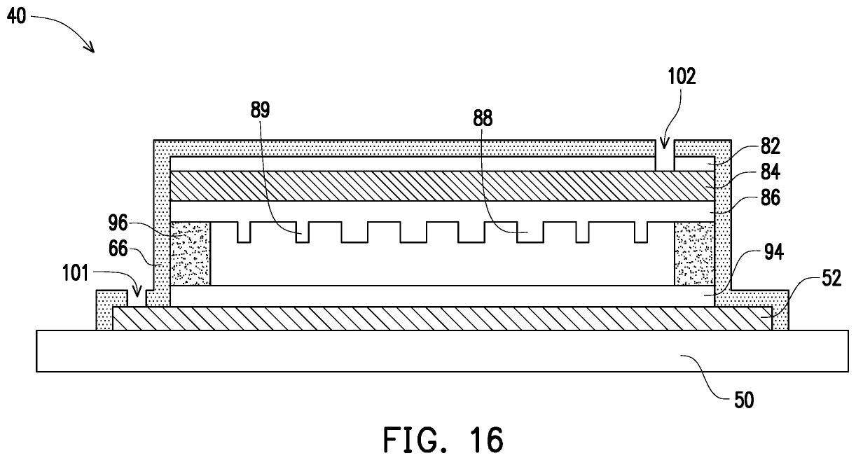

In FIG. 16, an opening 101 is formed in the passivation layer 66 to expose a top surface of the bottom electrode 52, and an opening 102 is formed in the passivation layer 66 and the dielectric layer 82 to expose a top surface of the top electrode 84. The openings 101 and 102 are formed using acceptable photolithography and etching techniques.

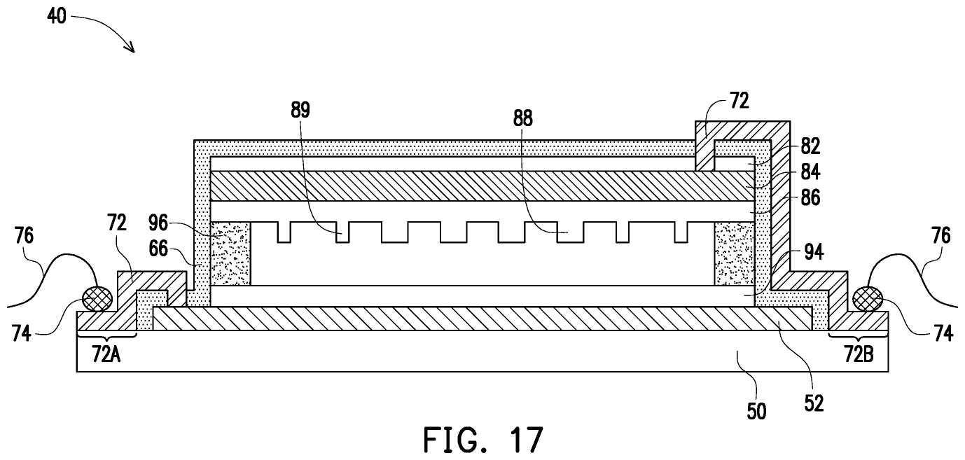

In FIG. 17, a conductive layer 72 (described previously in FIG. 8) is formed over the structure shown in FIG. 16 such as over the passivation layer 66 and the substrate 50. The conductive layer 72 also fills in the openings 101 and 102 such that the conductive layer 72 is in physical contact with the top electrode 84 and the bottom electrode 52. The conductive layer 72 is then patterned using acceptable photolithography and etching techniques to form a first conductive pad 72A on the substrate 50 that is electrically connected to the bottom electrode 52 and a second conductive pad 72B on the substrate 50 that is electrically connected to the top electrode 84, wherein the first conductive pad 72A and the second conductive pad 72B are not electrically connected to each other.

Still referring to FIG. 17, a wire bonding process is used to form conductive connectors 74 (described previously in FIG. 8) and bond wires 76 (described previously in FIG. 8) on the first conductive pad 72A and the second conductive pad 72B. A first voltage can be applied to the bottom electrode 52 using the first conductive pad 72A and the conductive connector 74 on the first conductive pad 72A. A second voltage can be applied to the top electrode 84 using the second conductive pad 72B and the conductive connector 74 on the second conductive pad 72B.

The embodiments of the present disclosure have some advantageous features. The embodiments include the forming of a transducer device that includes forming a first dielectric layer on a bottom electrode, and then patterning the first dielectric layer to form protrusions over the bottom electrode. The protrusions over a central portion of the bottom electrode may have larger widths than protrusions over an outer portion of the bottom electrode. A second dielectric layer is then formed over the first dielectric layer and the bottom electrode, and a cavity is formed in the second dielectric layer. A top electrode is then bonded to the second dielectric layer such that the cavity is disposed between the bottom electrode and the top electrode. One or more embodiments disclosed herein may include a reduction of accumulated charge in the first dielectric layer as a result of a smaller contact area due to the protrusions, leading to smaller shifts in transducer electrical performance and improved device reliability. In addition, there is mitigation of the higher contact stresses that are present in protrusions over the central portion as compared to the contact stresses that are present in protrusions over the outer portion because the protrusions over the central portion have larger widths. This results in reduced surface wear-out, and enhanced transducer device lifetime.

In accordance with an embodiment, a method of forming a transducer includes depositing a first dielectric layer on a first electrode; patterning the first dielectric layer to form first protrusions and second protrusions, where a first diameter of each of the first protrusions is larger than a second diameter of each of the second protrusions; and bonding the first dielectric layer to a second electrode using a second dielectric layer, where sidewalls of the second dielectric layer define a cavity disposed between the first electrode and the second electrode, and where the first protrusions are disposed in the cavity. In an embodiment, each of the first protrusions and the second protrusions has a circular shape in a top-down view, and where a ratio between an area of each of the first protrusions and an area of each of the second protrusions is in a range from 1.1:1 to 50:1. In an embodiment, the first protrusions are formed in a central region of the first dielectric layer and the second protrusions are formed in an outer region of the first dielectric layer, where the outer region surrounds the central region. In an embodiment, the central region and the outer region have circular outer perimeters. In an embodiment, the method further includes depositing the second dielectric layer over the first dielectric layer; and patterning the second dielectric layer to form the cavity, where bonding the first dielectric layer to the second electrode includes forming a third dielectric layer on the second electrode; and bonding the second dielectric layer to the third dielectric layer using dielectric-to-dielectric bonding. In an embodiment, patterning the first dielectric layer includes etching upper portions of the first dielectric layer. In an embodiment, after patterning the first dielectric layer, lower portions of the first dielectric layer have a thickness in a range from 0.001 μm to 0.5 μm. In an embodiment, coupling the first dielectric layer to the second electrode using the second dielectric layer includes bonding the second dielectric layer to the first dielectric layer using dielectric-to-dielectric bonding.

In accordance with an embodiment, a transducer device includes a bottom electrode over a substrate; a first dielectric layer over the bottom electrode, where the first dielectric layer includes first protrusions and second protrusions, where in a top-down view a first area of each of the first protrusions is larger than a second area of each of the second protrusions; a second dielectric layer over the first dielectric layer; a third dielectric layer disposed between the first dielectric layer and the second dielectric layer, where sidewalls of the third dielectric layer define a cavity in which the first protrusions and the second protrusions are disposed; and a top electrode over the second dielectric layer. In an embodiment, the first dielectric layer includes silicon oxide or doped silicon oxide. In an embodiment, the first protrusions are disposed in a central region of the first dielectric layer and the second protrusions are disposed in an outer region of the first dielectric layer, where the outer region surrounds the central region. In an embodiment, the transducer device further includes a passivation layer over the top electrode and the bottom electrode, where the passivation layer is in physical contact with top surfaces of the bottom electrode and the substrate; a first conductive layer over the passivation layer and electrically connected to the bottom electrode; a second conductive layer over the passivation layer and electrically connected to the top electrode; and first and second conductive connectors coupled to the first conductive layer and the second conductive layer, respectively. In an embodiment, a ratio between the first area of each of the first protrusions and the second area of each of the second protrusions is in a range from 1.1:1 to 50:1. In an embodiment, a first diameter of each of the first protrusions and a second diameter of each of the second protrusions is in a range from 0.5 μm to 10 μm. In an embodiment, the first diameter is larger than the second diameter.

In accordance with an embodiment, a transducer device includes a bottom electrode over a substrate; a first dielectric layer over the bottom electrode; a second dielectric layer over the first dielectric layer, where the second dielectric layer includes first protrusions and second protrusions, where a first diameter of each of the first protrusions is larger than a second diameter of each of the second protrusions; a third dielectric layer disposed between the first dielectric layer and the second dielectric layer, where sidewalls of the third dielectric layer define a cavity in which the first protrusions and the second protrusions are disposed; a top electrode over the second dielectric layer; and a passivation layer over the top electrode and the bottom electrode. In an embodiment, the first protrusions and the second protrusions include pillars, where each of the first protrusions and the second protrusions has a circular shape in a top-down view. In an embodiment, the first protrusions are disposed in a central region of the second dielectric layer and the second protrusions are disposed in an outer region of the second dielectric layer, where in the outer region surrounds the central region. In an embodiment, the transducer device further includes a first conductive connector electrically coupled to the bottom electrode through a first conductive layer; and a second conductive connector electrically coupled to the top electrode through a second conductive layer. In an embodiment, the first diameter is in a range from 3 μm to 10 μm and the second diameter is in a range from 0.5 μm to 2 μm.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of forming a transducer, the method comprising:
depositing a first dielectric layer on a first electrode;
patterning the first dielectric layer to form first protrusions and second protrusions, wherein a first diameter of each of the first protrusions is larger than a second diameter of each of the second protrusions; and
bonding the first dielectric layer to a second electrode using a second dielectric layer, wherein sidewalls of the second dielectric layer define a cavity disposed between the first electrode and the second electrode, and wherein the first protrusions are disposed in the cavity.

2. The method of claim 1, wherein each of the first protrusions and the second protrusions has a circular shape in a top-down view, and wherein a ratio between an area of each of the first protrusions and an area of each of the second protrusions is in a range from 1.1:1 to 50:1.

3. The method of claim 1, wherein the first protrusions are formed in a central region of the first dielectric layer and the second protrusions are formed in an outer region of the first dielectric layer, wherein the outer region surrounds the central region.

4. The method of claim 3, wherein the central region and the outer region have circular outer perimeters.

5. The method of claim 1, further comprising:
depositing the second dielectric layer over the first dielectric layer; and
patterning the second dielectric layer to form the cavity, wherein bonding the first dielectric layer to the second electrode comprises:
forming a third dielectric layer on the second electrode; and
bonding the second dielectric layer to the third dielectric layer using dielectric-to-dielectric bonding.

6. The method of claim 1, wherein patterning the first dielectric layer comprises etching upper portions of the first dielectric layer.

7. The method of claim 6, wherein after patterning the first dielectric layer, lower portions of the first dielectric layer have a thickness in a range from 0.001 μm to 0.5 μm.

8. The method of claim 1, wherein coupling the first dielectric layer to the second electrode using the second dielectric layer comprises bonding the second dielectric layer to the first dielectric layer using dielectric-to-dielectric bonding.

9. A transducer device comprising:
a bottom electrode over a substrate;
a first dielectric layer over the bottom electrode, wherein the first dielectric layer comprises first protrusions and second protrusions, wherein in a top-down view a first area of each of the first protrusions is larger than a second area of each of the second protrusions;
a second dielectric layer over the first dielectric layer;
a third dielectric layer disposed between the first dielectric layer and the second dielectric layer, wherein sidewalls of the third dielectric layer define a cavity in which the first protrusions and the second protrusions are disposed; and
a top electrode over the second dielectric layer.

10. The transducer device of claim 9, wherein the first dielectric layer comprises silicon oxide or doped silicon oxide.

11. The transducer device of claim 9, wherein the first protrusions are disposed in a central region of the first dielectric layer and the second protrusions are disposed in an outer region of the first dielectric layer, wherein the outer region surrounds the central region.

12. The transducer device of claim 11 further comprising:
a passivation layer over the top electrode and the bottom electrode, wherein the passivation layer is in physical contact with top surfaces of the bottom electrode and the substrate;
a first conductive layer over the passivation layer and electrically connected to the bottom electrode;
a second conductive layer over the passivation layer and electrically connected to the top electrode; and
first and second conductive connectors coupled to the first conductive layer and the second conductive layer, respectively.

13. The transducer device of claim 11, wherein a ratio between the first area of each of the first protrusions and the second area of each of the second protrusions is in a range from 1.1:1 to 50:1.

14. The transducer device of claim 11, wherein a first diameter of each of the first protrusions and a second diameter of each of the second protrusions is in a range from 0.5 μm to 10 μm.

15. The transducer device of claim 14, wherein the first diameter is larger than the second diameter.

16. A transducer device comprising:
a bottom electrode over a substrate;
a first dielectric layer over the bottom electrode;
a second dielectric layer over the first dielectric layer, wherein the second dielectric layer comprises first protrusions and second protrusions, wherein a first diameter of each of the first protrusions is larger than a second diameter of each of the second protrusions;
a third dielectric layer disposed between the first dielectric layer and the second dielectric layer, wherein sidewalls of the third dielectric layer define a cavity in which the first protrusions and the second protrusions are disposed;
a top electrode over the second dielectric layer; and
a passivation layer over the top electrode and the bottom electrode.

17. The transducer device of claim 16, wherein the first protrusions and the second protrusions comprise pillars, wherein each of the first protrusions and the second protrusions has a circular shape in a top-down view.

18. The transducer device of claim 16, wherein the first protrusions are disposed in a central region of the second dielectric layer and the second protrusions are disposed in an outer region of the second dielectric layer, where in the outer region surrounds the central region.

19. The transducer device of claim 18 further comprising:
a first conductive connector electrically coupled to the bottom electrode through a first conductive layer; and
a second conductive connector electrically coupled to the top electrode through a second conductive layer.

20. The transducer device of claim 16, wherein the first diameter is in a range from 3 μm to 10 μm and the second diameter is in a range from 0.5 μm to 2 μm.
